(19) United States
(12) Patent Application Publication
(10) Pub. No.: US 2005/0016811 A1
(43) Pub. Date: Jan. 27, 2005

(54) Apparatus for starting an internal combustion engine

(76) Inventor: James Cooper, Chatham, MA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/624,691

(22) Filed: Jul. 22, 2003

(51) Int. Cl. F16D 11/14

(52) U.S. Cl. 192/42

(57) ABSTRACT

A device for starting an internal combustion engine comprising a first clutch member attachable to the engine, and a second clutch member attachable to a portable drive means, wherein the first and second clutch members are engageable so that the drive means transmit force through the clutch members so as to turn and start the engine, and wherein, once the engine starts, the first and second clutch members automatically disengage from each other and wherein at least one of the first and second clutch members retracts. Preferably at least one of the first and second clutch members comprises resilient biassing means against retraction. A preferred embodiment relates to a lawnmower comprising such a device.

### FIELD OF THE INVENTION

The present invention relates to a device for starting an internal combustion engine.

### BACKGROUND OF THE INVENTION

Many internal combustion engines are not provided with a starter motor and must instead be started by an external force. Often, a rope or handle must be manually used to turn over the engine in order to start it.

However, this suffers from a number of disadvantages. Firstly, the action of manually starting an internal combustion engine can require a substantial force which a user, for example, an elderly person, may be unable to supply. It may also be necessary to repeat the exercise of turning the engine over several times before the engine starts. This is exacerbated under certain conditions, such as cold weather, where an even greater force is needed to start the engine. Another situation where problems arise is when an engine has been stored without fuel. Although known engines can include means to prime the engine with fuel before starting, the engine may still be difficult to start. Also, even when a person is able to turn over the engine, there remain the danger of injury caused by kick-back from the motor.

There have been proposed a number of devices for assisting in the starting of internal combustion engines. Some of these relate to the use of an electric drill to turn over the engine. However, none of these proposed methods or devices is believed to overcome all of the existing problems in order to provide a convenient and easy way to start an internal combustion engine.

There exists therefore a need for an improved apparatus for starting an internal combustion engine.

### SUMMARY OF THE INVENTION

According to the present invention there is provided a device for starting an internal combustion engine comprising a first clutch member attachable to the engine, and a second clutch member attachable to a portable drive means, wherein the first and second clutch members are engageable so that the drive means transmit force through the clutch members so as to turn and start the engine, and wherein, once the engine starts, the first and second clutch members automatically disengage from each other and wherein at least one of the first and second clutch members retracts.

Preferably, at least one of the first and second clutch members comprise resilient biasing means against retraction.

Conveniently, at least one of the first and second clutch members is resiliently biased by a spring.

Advantageously, the second clutch means is suitable for attachment to a portable drill.

Preferably, the first clutch member is suitable for attachment to a lawnmower engine.

Conveniently, the first clutch member is retractable.

Advantageously, the second clutch member is retractable.

Preferably, the retractable clutch member remains retracted when the clutch members disengage.

Conveniently, one of the clutch members is slidably mounted on a shaft.

Advantageously, the clutch member is prevented from rotating about the shaft.

Preferably, the first and second clutch members comprise a dog clutch.

According to another aspect of the present invention, there is provided a lawnmower comprising a first clutch member attached to an internal combustion engine wherein the first clutch member may engage with a second clutch member attached to a portable drive means so that the drive means transmit force through the clutch members so as to turn and start the engine, and wherein, once the engine starts, the first and second clutch members automatically disengage from each other and wherein at least one of the first and second clutch members retracts.

The invention will now be described, by way of example, with reference to the accompanying drawings in which:

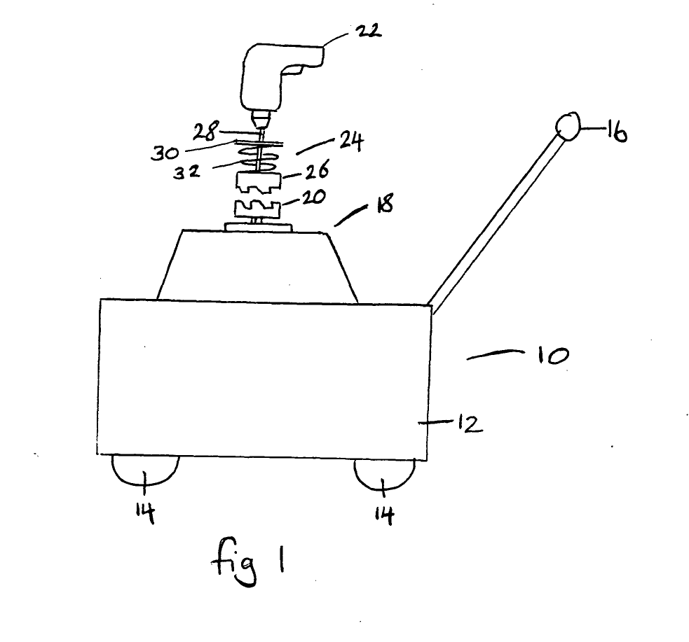

FIG. 1 is a side view of a lawnmower and a starting device of the invention;

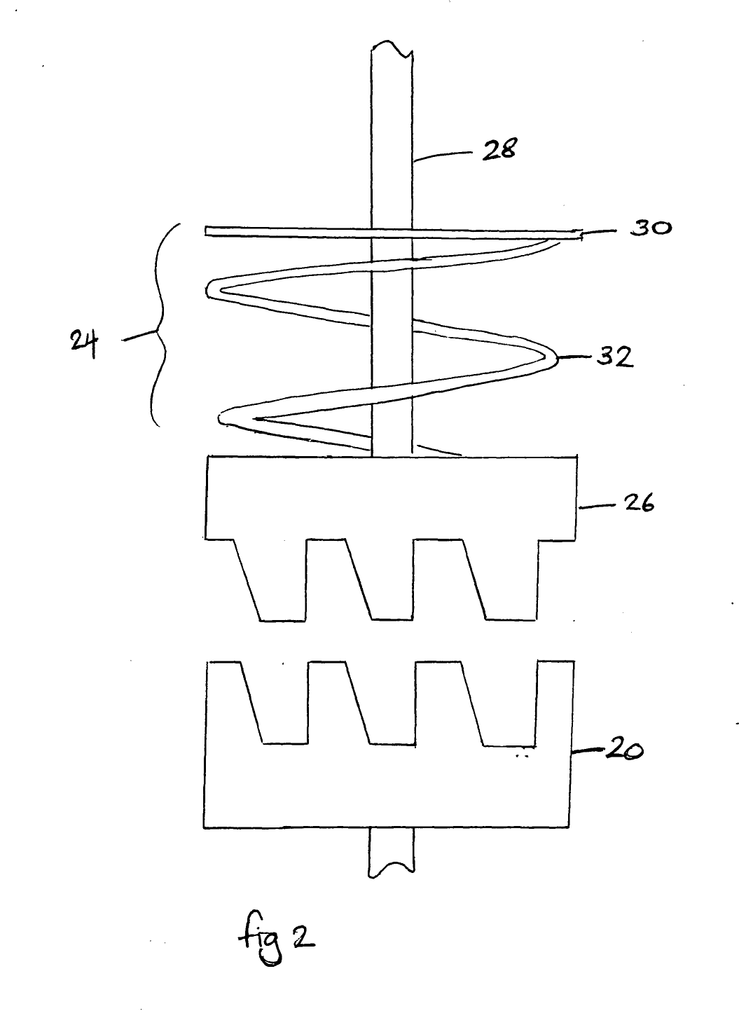

FIG. 2 is a side view of part of the starting device of the invention;

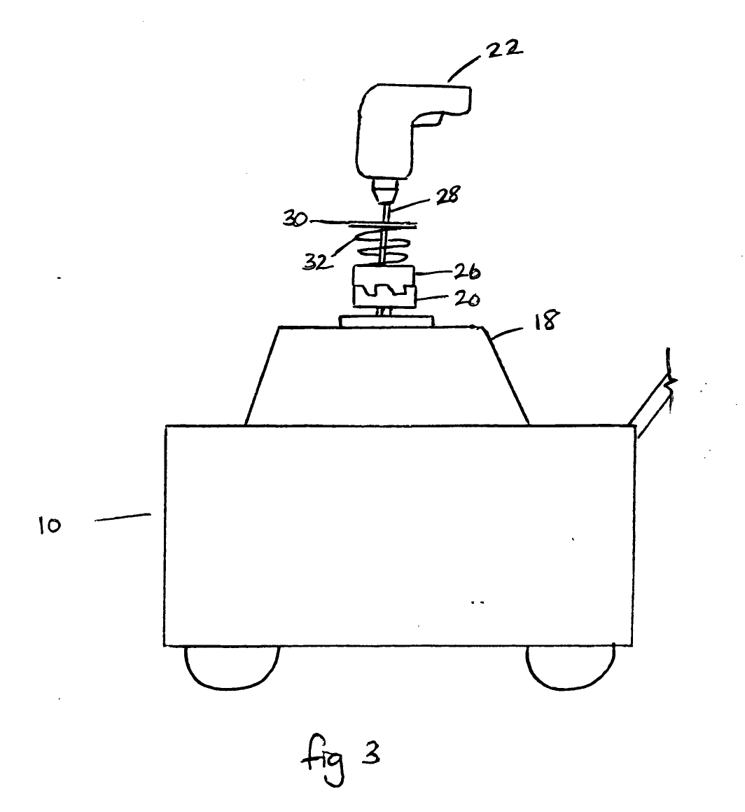

FIG. 3 is a side view of a lawnmower and a starting device of the invention engaged with a lawnmower engine before the engine has started;

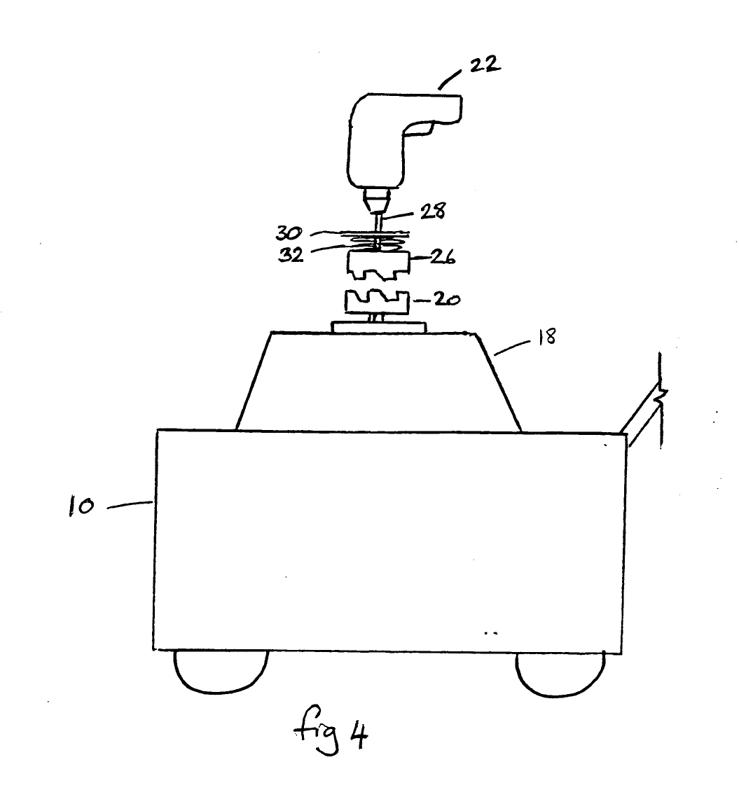

FIG. 4 is a view corresponding to FIG. 3 after the engine has started;

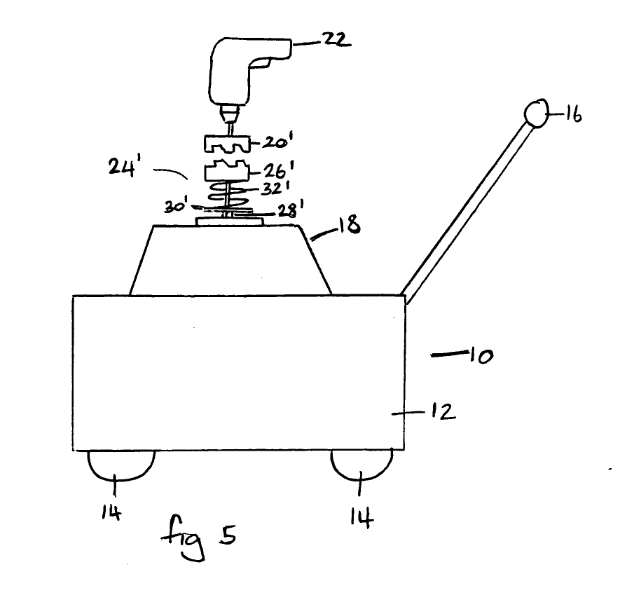

FIG. 5 is a side view of a lawnmower and an alternative embodiment of the device of the invention; and

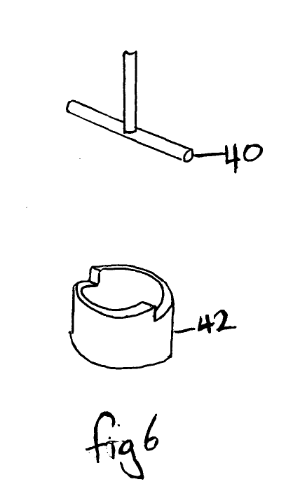

FIG. 6 is a perspective view of part of an alternative embodiment of the clutch members of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents and alternatives falling within the spirit and scope of the invention as described by the appended claims.

### DETAILED DESCRIPTION OF THE PREFERRED EMBODIMENT

A lawnmower is shown generally at 10 and is of conventional construction. It comprises a main body 12, four wheels 14, a handle 16 and an engine indicated generally at 18.

A first clutch member 20 is attached to the flywheel of the engine 18. The first clutch member 20 comprises a substantially circular disc with an upstanding annular wall. The annular wall defines a series of asymmetric notches. There is also provided an electric drill 22 in the chuck of which is mounted a starting device indicated generally at 24. The construction of the first and second clutch members can be more easily understood with reference to FIG. 2. The starting device 24 comprises a shaft 28 extending from the drill bit of the drill 22. Fixed on the shaft 28 is located a substantially circular disc 30. The disc 30 supports a coil spring 32 extending away from the drill 22. Towards the end of the shaft 28 there is mounted a second clutch member 26. The second clutch member 26 is of similar configuration to the first clutch member 20 and has complementary asymmetric notches.

A notch of the first clutch member 20 as attached to a lawnmower will now be described. A first wall is directed substantially perpendicularly to the axis between the first clutch member and the lawnmower and thus defines the distal edge of the notch. A second wall is directed towards the lawnmower substantially parallel with the axis between the first clutch member and the lawnmower. A third wall, of shorter length than the first wall, is directed substantially parallel with the first wall, defining the proximal edge of the notch. A fourth wall is directed away from the lawnmower towards the distal end of the clutch member at an angle away from the first wall. The notch thus tapers away from a smaller width at the proximal edge to a greater width at the distal edge. This pattern is repeated around the annular wall of the first clutch member to define a regular series of notches. The second clutch member is provided with a corresponding complementary set of notches which mesh together with the notches in the first clutch member.

The second clutch member 26 is slidably mounted upon the shaft 28 but is prevented by rotation about the shaft 28. The spring 32 biases the second clutch member 26 towards the end of the shaft 28 but allows the second clutch member 26 to move some distance towards the disc 30.

As shown in FIG. 3, in use, the drill 22 and apparatus 24 are aligned with the first clutch member 20 and the second clutch member 26 is brought into contact with the first clutch member 20. The complementary asymmetric notches of the first and second clutch members 20 and 26 mate together. The notches are shaped so as to allow the drill 22 to efficiently transmit drive through to the engine 18. Thus, once the first and second clutch members are engaged and the drill 22 is switched on, the engine 18 is forced to turn over, as will be explained below.

FIG. 5 shows a further embodiment of the invention with the positions of the first and second clutch members 20′ and 26′ being reversed with respect to the embodiment shown in FIG. 1. In this embodiment, the first clutch member 20′ is attached to the drill 22. The starting arrangement 24′ is attached to the engine 18. Once the first and second clutch members 20′ and 26′ are engaged and the drill 22 is turned on, the engine 18 is turned over as explained above. Again, if the engine turns the second clutch member 26′ faster than the first clutch member 20′, they will automatically disengage, with the second clutch member 26′ being forced down towards the engine 18.

Once the engine 18 starts, the drill 22 and apparatus 24 may be pulled away from the clutch member 20. However, if the engine 18 forces the first clutch member 20 to turn at a rate faster than that of the second clutch member 26, the asymmetric shape of the notches in the first and second clutch members forces them apart. The second clutch member 26 would be thrown away from the engine 18 towards the drill 22 to reach the situation shown in FIG. 4. Thus, the distance between the drill 22 and the second clutch member 26 has decreased. In other words, the second clutch member 26 has retracted. The axial shock of this movement is absorbed by the spring 32, reducing the force passed to the user of the drill 22. After retraction, the second clutch member 26 would be pushed back away from the drill 22 by the spring 32. The drill 22 and attached arrangement 24 can then be safely withdrawn away from the engine 18.

In an alternative embodiment, there is provided a catch on the shaft 28 which allows the second clutch member 26 to travel towards the disc 30 to reach the position shown in FIG. 4, but prevents the return of member 26 towards the terminus of the shaft 28. Thus, in this embodiment, if the second clutch member 26 is thrown from the first clutch member 20 the shock is absorbed by the spring 32 and second clutch member is safely retained by the catch away from the engine 18. In other words, the second clutch member 26 undergoes retraction without immediately moving back away from the drill 22. The user may return the second clutch member 26 to its initial position by releasing the catch. Thus any injury or shock caused by the kick-back from the motor 18 to the user of the drill 22 is prevented.

FIG. 5 shows a further embodiment of the invention with the positions of the first and second clutch members 20′ and 26′ being reversed with respect to the embodiment shown in FIG. 1. In this embodiment, the first clutch member 20′ is attached to the drill 22. The starting arrangement 24′ is attached to the engine 18. Once the first and second clutch members 20′ and 26′ are engaged and the drill 22 is turned on, the engine 18 is turned over as explained above. Again, if the engine turns the second clutch member 26′ faster than the first clutch member 20′, they will automatically disengage, with the second clutch member 26′ being forced down towards the engine 18. In this embodiment, the first clutch member 20 undergoes retraction towards the engine 18. In an alternative embodiment, means may be provided to prevent the immediate return of the retracted clutch member to its initial position.

It is to be appreciated that numerous forms and configuration of the first and second clutch members could be used which allow them to automatically disengage once the engine has started.

FIG. 6 shows an alternative arrangement of a first clutch member 40, comprising a diametrically extending bar, and a second clutch member 42, comprising an annular wall defining two asymmetric notches. If the first clutch member 40 is brought into contact with the second clutch member 42 and is turned in one direction, drive may be transmitted as described above. If the first clutch member is turned in the other direction, the members automatically disengage from each other.

Although the invention has been described in relation to the starting of a lawnmower, it is to be appreciated that it is also applicable to other engines. For example, the invention also applies to chainsaws, strimmers, outboard engines, generators, compressors and other such devices.

The above specification provides a complete description of the invention. Since many embodiments of the invention can be made to work without departing from the spirit and scope of the invention, the invention resides in the appended claims.

1. A device for starting an internal combustion engine comprising a first clutch member attachable to the engine, and a second clutch member attachable to a portable drive means, wherein the first and second clutch members are engageable so that the drive means transmit force through the clutch members so as to turn and start the engine, and wherein, once the engine starts, the first and second clutch members automatically disengage from each other and wherein at least one of the first and second clutch members retracts.

2. A device according to claim 1 wherein at least one of the first and second clutch members comprise resilient biasing means against retraction.

3. A device according to claim 2 wherein at least one of the first and second clutch members is resiliently biased by a spring.

4. A device according to claim 1 wherein the second clutch means is suitable for attachment to a portable drill.

5. A device according to claim 1 wherein the first clutch member is suitable for attachment to a lawnmower engine.

6. A device according to claim 1 wherein the first clutch member is retractable.

7. A device according to claim 1 wherein the second clutch member is retractable.

8. A device according to claim 1 wherein the retractable clutch member remains retracted when the clutch members disengage.

9. A device according to claim 1 wherein one of the clutch members is slidably mounted on a shaft.

10. A device according to claim 9 wherein the clutch member is prevented from rotating about the shaft.

11. A device according to claim 1 wherein the first and second clutch members comprise a dog clutch.

12. A lawnmower comprising a first clutch member attached to an internal combustion engine wherein the first clutch member may engage with a second clutch member attached to a portable drive means so that the drive means transmit force through the clutch members so as to turn and start the engine, and wherein, once the engine starts, the first and second clutch members automatically disengage from each other and wherein at least one of the first and second clutch members retracts.
